(19) United States
(12) Patent Application Publication
(10) Pub. No.: US 2026/0268918 A1
(43) Pub. Date: Sep. 10, 2026

(54) SPEECH PROCESSING METHOD AND APPARATUS, AND ELECTRONIC DEVICE

(71) Applicants: DOUYIN VISION CO., LTD., Beijing (CN); LEMON INC., Grand Cayman (KY)

(72) Inventors: Dongya Jia, Beijing (CN); Qiao Tian, Beijing (CN); Jiaxin Li, Beijing (CN); Yuanzhe Chen, Beijing (CN); Mingbo Ma, CULVER CITY, CA (US); Yuping Wang, Beijing (CN); Yuxuan Wang, Los Angeles, CA (US)

(21) Appl. No.: 18/876,540

(22) PCT Filed: Oct. 23, 2023
(86) PCT No.: PCT/CN2023/126042

§ 371 Date: Dec. 18, 2024

(30) Foreign Application Priority Data
Dec. 8, 2022 (CN) 202211575466.5

(51) Int. Cl. G10L 21/007; G06F 3/0484; G06F 3/0488; G10L 15/02; G10L 15/06

(52) U.S. Cl. CPC G10L 21/007; G10L 15/02; G10L 15/063; G06F 3/0484; G06F 3/0488; G10L 2015/0635

(57) ABSTRACT

Provided are a speech processing method and apparatus, and an electronic device. The method includes: displaying an accent conversion page, where the accent conversion page includes an accent control associated with a target accent, and a speech obtaining control; determining an identifier of the target accent in response to a touch operation on the accent control; obtaining first speech in response to a touch operation on the speech obtaining control, where the target accent is different from an accent of the first speech; performing accent conversion on the first speech based on the first speech and the identifier of the target accent, to obtain second speech, where an accent of the second speech is the target accent, the accent conversion is implemented based on a speech processing model, and the speech processing model is obtained through training based on sample speech of non-parallel data; and playing the second speech.

### CROSS-REFERENCE TO RELATED APPLICATION(S)

This application is a U.S. National Stage Application of PCT Application Serial No. PCT/CN2023/126042, filed on Oct. 23, 2023, which claims priority to Chinese Patent Application No. 202211575466.5, filed on Dec. 8, 2022 and entitled “SPEECH PROCESSING METHOD AND APPARATUS, AND ELECTRONIC DEVICE”, the disclosures of which are incorporated herein by reference in their entireties.

### FIELD

Embodiments of the present disclosure relate to the technical field of speech processing, and in particular, to a speech processing method and apparatus, and an electronic device.

### BACKGROUND

Accent conversion refers to a change of an accent of a segment of speech, where the accent refers to a varying feature of the degree of modular emphasis on words or specific syllables. For example, the accent may include Shaanxi-accented mandarin, Hong Kong-accented mandarin, etc.

### SUMMARY

Embodiments of the present disclosure provide a speech processing method and apparatus, and an electronic device, so as to solve the technical problem of low accuracy of accent conversion in the prior art.

According to a first aspect, the present disclosure provides a speech processing method. The method includes:
displaying an accent conversion page, where the accent conversion page includes an accent control associated with a target accent, and a speech obtaining control;
determining an identifier of the target accent in response to a touch operation on the accent control;
obtaining the first speech in response to a touch operation on the speech obtaining control, where the target accent is different from an accent of the first speech;
performing accent conversion on the first speech based on the first speech and the identifier of the target accent, to obtain second speech, where an accent of the second speech is the target accent, the accent conversion is implemented based on a speech processing model, and the speech processing model is obtained by training based on sample speech of non-parallel data; and
   playing the second speech.

According to a second aspect, the present disclosure provides a speech processing apparatus. The speech processing apparatus includes a display module, a response module, a processing module, and a play module, where
the display module is configured to display an accent conversion page, where the accent conversion page includes an accent control associated with a target accent, and a speech obtaining control;
the response module is configured to determine an identifier of the target accent in response to a touch operation on the accent control;
the response module is further configured to obtain the first speech in response to a touch operation on the speech obtaining control, where the target accent is different from an accent of the first speech;
the processing module is configured to perform accent conversion on the first speech based on the first speech and the identifier of the target accent, to obtain second speech, where an accent of the second speech is the target accent, the accent conversion is implemented based on a speech processing model, and the speech processing model is obtained by training based on sample speech of non-parallel data; and
the play module is configured to play the second speech.

According to a third aspect, an embodiment of the present disclosure provides an electronic device. The electronic device includes: a processor and a memory,
where the memory stores computer-executable instructions; and
the processor executes the computer-executable instructions stored in the memory, to cause the processor to perform the speech processing method according to the first aspect and various possible designs of the first aspect.

According to fourth aspect, an embodiment of the present disclosure provides a computer-readable storage medium, where the computer-readable storage medium stores computer-executable instructions that, when executed by a processor, cause the speech processing method according to the first aspect and various possible designs of the first aspect to be implemented.

According to a fifth aspect, an embodiment of the present disclosure provides a computer program product including a computer program that, when executed by a processor, causes the speech processing method according to the first aspect and various possible designs of the first aspect to be implemented.

The present disclosure provides the speech processing method and apparatus, and the electronic device. The electronic device may display an accent conversion page, where the accent conversion page includes an accent control associated with the target accent, and a speech obtaining control; determine an identifier of the target accent in response to a touch operation on the accent control; obtain first speech in response to a touch operation on the speech obtaining control, where the target accent is different from the accent of the first speech; perform the accent conversion on the first speech based on the first speech and the identifier of the target accent, to obtain second speech; and play the second speech, where the accent of the second speech is the target accent, the accent conversion is implemented based on a speech processing model, and the speech processing model is obtained through the training based on sample speech of non-parallel data.

### BRIEF DESCRIPTION OF THE DRAWINGS

In order to more clearly describe the technical solutions in the embodiments of the present disclosure or in the prior art, the accompanying drawings for describing the embodiments or the prior art will be briefly described below. Apparently, the accompanying drawings in the description below show some embodiments of the present disclosure, and persons of ordinary skill in the art may still derive other accompanying drawings from these accompanying drawings without creative efforts.

FIG. 1 is a schematic diagram of an application scenario according to an embodiment of the present disclosure;

FIG. 2 is a schematic flowchart of a speech processing method according to an embodiment of the present disclosure;

FIG. 3 is a schematic diagram of a process of obtaining first speech according to an embodiment of the present disclosure;

FIG. 4 is a schematic diagram of another process of obtaining first speech according to an embodiment of the present disclosure;

FIG. 5 is a schematic diagram of a structure of a speech processing model according to an embodiment of the present disclosure;

FIG. 6 is a schematic diagram of a process of a speech processing method according to an embodiment of the present disclosure;

FIG. 7 is a schematic flowchart of a method for training a speech processing model according to an embodiment of the present disclosure;

FIG. 8 is a schematic diagram of a structure of a speech processing model during training according to an embodiment of the present disclosure;

FIG. 9 shows a training process of a speech processing model according to an embodiment of the present disclosure;

FIG. 10 shows another training process of a speech processing model according to an embodiment of the present disclosure;

FIG. 11 is a schematic diagram of a structure of a speech processing apparatus according to an embodiment of the present disclosure;

FIG. 12 is a schematic diagram of a structure of another speech processing apparatus according to an embodiment of the present disclosure; and

FIG. 13 is a schematic diagram of a structure of an electronic device according to an embodiment of the present disclosure.

### DETAILED DESCRIPTION OF EMBODIMENTS

Exemplary embodiments are described in detail herein, and examples thereof are illustrated in the accompanying drawings. When the following description relates to the accompanying drawings, the same numerals in different accompanying drawings denote the same or similar elements, unless otherwise indicated. The implementations described in the following exemplary embodiments do not represent all the implementations consistent with the present disclosure. Rather, they are merely examples of apparatuses and methods that are consistent with some aspects of the present disclosure and that are described in detail in the appended claims.

For ease of understanding, concepts involved in the embodiments of the present disclosure are described below.

Electronic device: a device with a wireless transceiving function. The electronic device may be deployed on land, including indoors or outdoors, handheld, wearable, or vehicle-mounted; or may be deployed on water (for example, a ship, etc.). The electronic device may be a mobile phone, a tablet computer (Pad), a computer having a wireless transceiver function, a virtual reality (VR) electronic device, an augmented reality (AR) electronic device, a wireless terminal in industrial control, a vehicle-mounted electronic device, a wireless terminal in self-driving, a wireless electronic device in remote medical, a wireless electronic device in a smart grid, a wireless electronic device in transportation safety, a wireless electronic device in a smart city, a wireless electronic device in a smart home, a wearable electronic device, or the like. The electronic device in the embodiments of the present disclosure may also be referred to as a terminal, user equipment (UE), an access electronic device, a vehicle-mounted terminal, an industrial control terminal, a UE unit, a UE station, a mobile station, a mobile console, a remote station, a remote electronic device, a mobile device, a UE electronic device, a wireless communication device, a UE agent, a UE apparatus, etc. The electronic device may be stationary or mobile.

Currently, when an electronic device converts an accent of original speech into another accent, the electronic device may obtain, based on the text content of the original speech and from a database, speech of another accent that has the text content of the original speech, and perform timbre conversion on the speech of the another accent, so that a timbre of the speech of the another accent is the same as a timbre of the original speech, thereby achieving accent conversion of the original speech.

However, the above method is actually timbre conversion of the speech, and if in the database, there is no speech of the other accent that has text content the same as the text content of the original speech, the electronic device cannot accurately perform accent conversion, thus causing low accuracy of the accent conversion.

In the related art, an accent conversion technology can change an accent of a segment of speech. For example, an accent of a segment of speech is Shaanxi-accented mandarin, and the accent conversion technology can convert the accent of the segment of speech into Hong Kong-accented mandarin. Currently, the electronic device may match reference speech in a database with original speech based on text content of the original speech, where text content of the reference speech is the same as that of the original speech, a timbre of the reference speech is different from that of the original speech, and an accent of the reference speech is an accent to be obtained by conversion. The electronic device may convert the timbre of the reference speech into the timbre of the original speech, so as to achieve accent conversion of the original speech. For example, if the original speech is Shaanxi-accented mandarin speech “Nihao (Hello)” spoken by a user A and is to be converted into Hong Kong-accented mandarin speech, the electronic device can obtain Hong Kong-accented mandarin speech “Nihao” spoken by a user B in the database, and convert a timbre of the speech spoken by the user B into a timbre of the speech spoken by the user A, thereby performing accent conversion on the speech spoken by the user A.

However, the above method is actually timbre conversion of the speech. For example, the electronic device just converts the timbre of the speech input by the user B into the timbre of the speech input by the user A, so as to obtain the Hong Kong-accented mandarin speech “Nihao” input by the user A. If in the database, there is no speech of another accent that has text content the same as the text content of the original speech, the electronic device cannot accurately perform accent conversion, thus causing low accuracy of accent conversion.

In order to solve the above technical problem, an embodiment of the present disclosure provides a speech processing method. The electronic device may display an accent conversion page including an accent control associated with a target accent, and a speech obtaining control; determine an identifier of the target accent in response to a touch operation on the accent control; obtain first speech in response to a touch operation on the speech obtaining control; determine a target accent feature based on the identifier of the target accent; process the first speech based on a speech processing model, to obtain a text feature and a timbre feature associated with the first speech; process the text feature, the timbre feature, and the target accent feature based on the speech processing model, to obtain second speech; and play the second speech, where an accent of the second speech is the target accent, and a timbre and content of the second speech are the same as those of the first speech. As such, for any segment of speech, based on the speech processing model, the electronic device can extract a text feature and a timbre feature of the segment of speech and merge them with the target accent feature of the target accent, thereby obtaining the speech after accent conversion. The electronic device does not need to obtain, from the database, speech of another accent that has the same text content. The speech processing model can accurately perform accent conversion on any segment of speech, and can retain a timbre and content of the speech, thereby improving the accuracy of accent conversion.

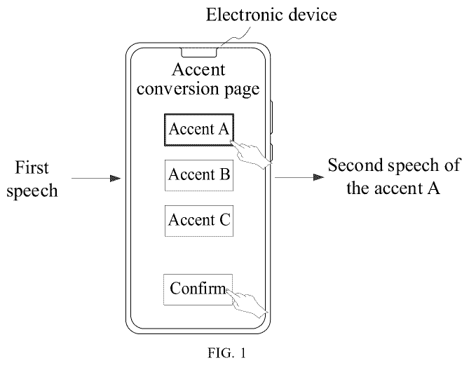

An application scenario of an embodiment of the present disclosure is described below with reference to FIG. 1.

FIG. 1 is a schematic diagram of an application scenario according to an embodiment of the present disclosure. Referring to FIG. 1, a electronic device is included. A display page of the electronic device is the accent conversion page, where the accent conversion page includes a control for an accent A, a control for an accent B, a control for an accent C, and a confirm control. When the electronic device receives the first speech, the electronic device determines that the target accent is the accent A in response to a touch operation on the control for the accent A, and the electronic device may generate the second speech in response to a touch operation on the confirm control, where the accent of the second speech is the accent A, and the content and timbre of the second speech are the same as the content and timbre of the first speech. As such, the electronic device does not need to obtain speech of the target accent that has text content the same as that of the first speech from the database. The electronic device can accurately perform accent conversion on any segment of the first speech, and can retain the timbre and content of the first speech, thereby improving the accent conversion accuracy.

It should be noted that FIG. 1 illustrates only an application scenario of the embodiments of the present disclosure in the form of an example, and does not limit the application scenario of the embodiments of the present disclosure.

The technical solutions of the present disclosure and how the technical solutions of the present disclosure solve the above technical problem are described below in detail with specific embodiments. The following several specific embodiments may be combined with each other, and details about same or similar concepts or processes may not be described in some embodiments again. The embodiments of the present disclosure are described below with reference to the accompanying drawings.

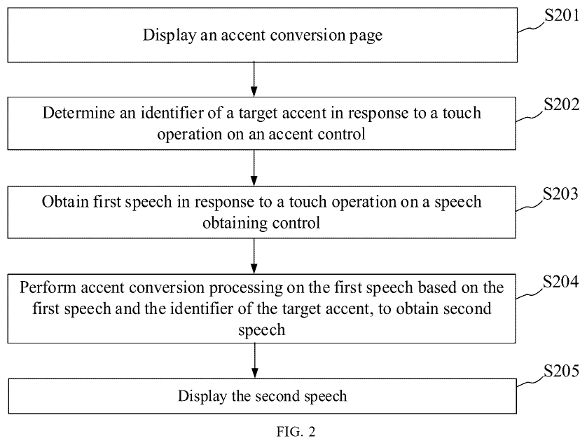

FIG. 2 is a schematic flowchart of a speech processing method according to an embodiment of the present disclosure. Referring to FIG. 2, the method may include the following steps.

S201: An accent conversion page is displayed.

An execution subject of this embodiment of the present disclosure may be an electronic device or may be a speech processing apparatus provided in the electronic device. Alternatively, the speech processing apparatus may be implemented by software, or the speech processing apparatus may be implemented by a combination of software and hardware. This is not limited in the embodiments of the present disclosure.

Alternatively, the accent conversion page includes an accent control associated with a target accent, and a speech obtaining control. Alternatively, the target accent may be an accent to be converted into. For example, if the electronic device converts an accent of speech into an accent A, the target accent may be the accent A, and if the electronic device converts an accent of speech into an accent B, the target accent may be the accent B.

The accent control may be used to determine the target accent. For example, the accent conversion page may include a control for the accent A and a control for the accent B. If a user clicks on the control for the accent A, the target accent for accent conversion is the accent A, and if the user clicks on the control for the accent B, the target accent for accent conversion is the accent B.

The speech obtaining control can obtain speech. For example, the speech obtaining control may be a record control that allows the electronic device to obtain speech in real time when the user clicks on the record control. For example, when the user clicks on the speech obtaining control, the electronic device may display a page including a plurality of speech file controls, and the user may click on any of the speech file controls to determine target speech.

Alternatively, in response to a touch operation on an accent conversion application, the electronic device may display the accent conversion page. For example, when the user clicks on the accent conversion application on a display page of the electronic device, the electronic device may display the accent conversion page, where the accent conversion page may include at least one control for the target accent and the speech obtaining control.

S202: An identifier of a target accent is determined in response to a touch operation on an accent control.

Alternatively, the identifier of the target accent may be any identifier (for example, a serial number, a name, etc.), which is not limited in the embodiments of the present disclosure.

Alternatively, the electronic device may determine the identifier of the target accent in response to the touch operation on the accent control by the user on an accent conversion page. For example, when the accent conversion page displayed on the electronic device includes the control for the accent A and the control for the accent B, if the user clicks on the control for the accent A, the electronic device may determine that the identifier of the target accent is an identifier of the accent A, and if the user clicks on the control for the accent B, the electronic device may determine that the identifier of the target accent is an identifier of the accent B.

S203: First speech is obtained in response to a touch operation on a speech obtaining control.

Alternatively, the first speech may be speech of any user. Alternatively, the target accent may be different from an accent of the first speech. For example, if the accent of the first speech is the accent A, the target accent may be another accent other than the accent A, and if the accent of the first speech is the accent B, the target accent may be another accent other than the accent B.

Alternatively, obtaining first speech in response to a touch operation on a speech obtaining control may be implemented in the following two feasible implementations.

One feasible implementation is as follows:

A speech page is displayed in response to the touch operation on the speech obtaining control. The speech page includes at least one piece of target speech. For example, when the user clicks on the speech obtaining control on the accent conversion page, the display page of the electronic device jumps from the accent conversion page to the speech page, where the speech page may include files of a plurality of segments of speech.

The target speech is determined as the first speech in response to a touch operation on the target speech. For example, the speech page includes a file of target speech A and a file of target speech B. If the user clicks on the file of the target speech A, the electronic device determines the target speech A as the first speech, and if the user clicks on the file of the target speech B, the electronic device determines the target speech B as the first speech.

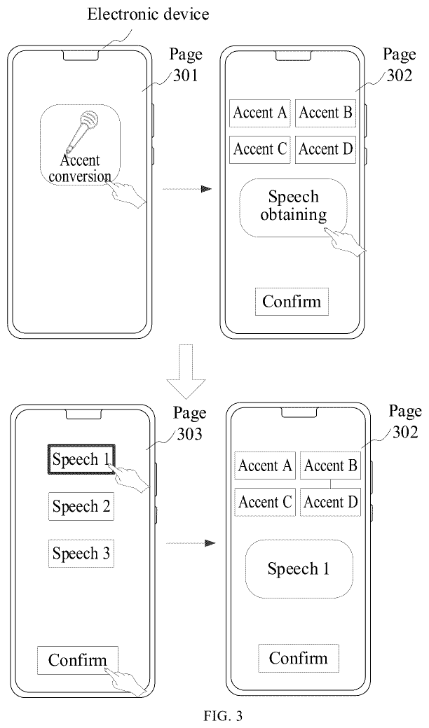

A process of obtaining the first speech is described below with reference to FIG. 3.

FIG. 3 is a schematic diagram of the process of obtaining the first speech according to an embodiment of the present disclosure. Referring to FIG. 3, an electronic device is included. The display page of the electronic device is a page 301, where the page 301 includes an application for accent conversion. After the user clicks on the application for accent conversion, the display page of the electronic device jumps from the page 301 to a page 302.

Referring to FIG. 3, the page 302 includes a control for the accent A, a control for the accent B, a control for an accent C, a control for an accent D, the speech obtaining control, and a confirm control. After the user clicks on the speech obtaining control, the display page of the electronic device jumps from the page 302 to a page 303.

Referring to FIG. 3, the page 303 includes a control for speech 1, a control for speech 2, a control for speech 3, and a confirm control. When the user clicks on the control for the speech 1, the border of the control for the speech 1 is highlighted. After the user clicks on the confirm control, a jump from the page 303 to the page 302 is made on the electronic device, and the speech A is determined as the first speech obtained by the electronic device.

In the above feasible implementation, the electronic device may store a plurality of pieces of speech in advance, and in response to an operation of the user, the electronic device may determine any segment of speech as the first speech, thereby improving the flexibility of obtaining the first speech.

The other feasible implementation is as follows:

Speech recording is performed in response to the touch operation on the speech obtaining control, to obtain the first speech. For example, the electronic device may start recording when the user clicks on the speech obtaining control on the accent conversion page, and the electronic device may determine recorded speech of the user as the first speech.

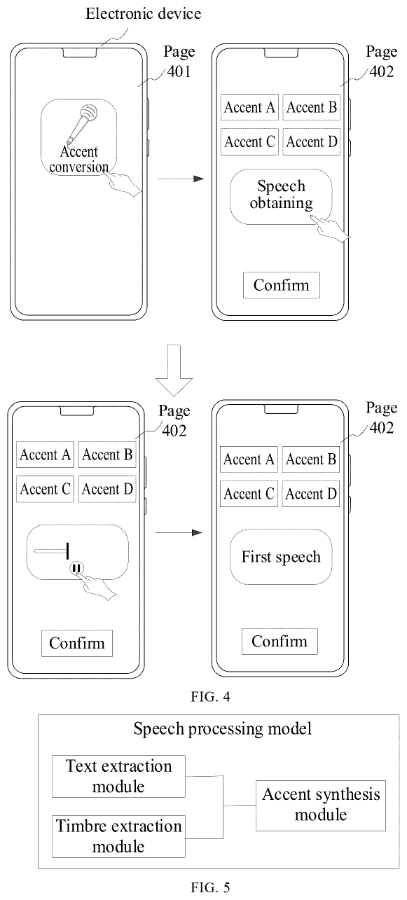

A process of obtaining the first speech in this case is described below with reference to FIG. 4.

FIG. 4 is a schematic diagram of another process of obtaining the first speech according to an embodiment of the present disclosure. Referring to FIG. 4, the electronic device is included. The display page of the electronic device is a page 401, where the page 401 includes an application for accent conversion. After the user clicks on the application for accent conversion, the display page of the electronic device jumps from the page 401 to a page 402.

Referring to FIG. 4, the page 402 includes the control for the accent A, the control for the accent B, the control for the accent C, the control for the accent D, the speech obtaining control, and the confirm control. When the user clicks on the speech obtaining control, the electronic device starts to record speech of the user. When the user clicks on a record stop control, the electronic device stops recording speech of the user, and determines the recorded speech of the user as the first speech.

In the above feasible implementation, the electronic device may obtain speech of the user in real time, and determine the speech of the user as the first speech, thereby improving the flexibility of obtaining the first speech.

S204: Accent conversion on the first speech is performed based on the first speech and the identifier of the target accent, to obtain second speech.

An accent of the second speech is the target accent, and a timbre and content of the second speech is the same as those of the first speech. For example, if the content of the first speech may be “Nihao”, the timbre of the first speech may be a timbre of a user A, the accent of the first speech may be an accent 1, and the target accent is an accent 2, then the content of the second speech may be “Nihao”, the timbre of the second speech may be the timbre of the user A, and the accent of the second speech may be the accent 2.

The accent conversion on the first speech is implemented based on a speech processing model. Alternatively, the speech processing model is obtained by training based on sample speech of non-parallel data. Alternatively, the sample speech of non-parallel data includes a plurality of pieces of text associated with a plurality of different accents, where content of the plurality of pieces of text may vary. For example, the sample speech of non-parallel data may include speech of a plurality of accents of a plurality of users. For example, the sample speech may include the speech 1 of an accent a that is spoken by the user A, the speech 2 of an accent b that is spoken by the user A, and the speech 3 of an accent c that is spoken by the user B, where content of the speech 1, the speech 2, and the speech 3 varies. It should be noted that the sample speech of non-parallel data may include any type of speech, which is not limited in the embodiments of the present disclosure. The speech processing model may be trained based on the sample speech of non-parallel data.

Alternatively, the electronic device may obtain the second speech based on the following feasible implementation: a target accent feature is determined based on the identifier of the target accent. For example, the electronic device may include the speech processing model. After receiving the identifier of the target accent, the speech processing model may determine the target accent feature in learned accent features, where the target accent feature may indicate information about the target accent, and the target accent feature may be a vector of N*M (both N and M are integers greater than 0) or may be a feature map, which is not limited in the embodiments of the present disclosure.

The first speech is processed based on the speech processing model, to obtain a text feature and a timbre feature associated with the first speech. For example, the text feature may indicate text information in the first speech, the timbre feature may indicate timbre information in the first speech, and the text feature and the timbre feature may be multi-dimensional vectors or feature maps, which is not limited in the embodiments of the present disclosure. For example, the speech processing model may include a text extraction module and a timbre extraction module. The electronic device processes the first speech through the text extraction module, where the text extraction module may filter out information in the first speech that is unrelated to the text content and retain the text information in the first speech, thereby obtaining the text feature associated with the first speech. The electronic device processes the first speech through the timbre extraction module, where the timbre extraction module may filter out information in the first speech that is unrelated to the timbre and retain the timbre information in the first speech, thereby obtaining the timbre feature associated with the first speech.

The text feature, the timbre feature, and the target accent feature are processed based on the speech processing model, to obtain the second speech. For example, the speech processing model further includes an accent synthesis module. It should be noted that the accent synthesis module may learn the target accent feature during training, and the accent synthesis module generates the second speech based on the input text feature and timbre feature as well as the learned target accent feature.

It should be noted that a plurality of accent synthesis modules may be included in the speech processing model, where each accent synthesis module may learn one accent feature during training, allowing the speech processing model to perform conversion between a plurality of accents. For example, after receiving the identifier of the target accent, the speech processing model may determine an accent synthesis module that have learned the target accent feature, and then process the text feature and the timbre feature through the accent synthesis module, so as to obtain the speech of the target accent.

A structure of the speech processing model is described below with reference to FIG. 5.

FIG. 5 is a schematic diagram of the structure of the speech processing model according to an embodiment of the present disclosure. Referring to FIG. 5, the speech processing model is included. The speech processing model may include a text extraction module, a timbre extraction module, and an accent synthesis module, where the accent synthesis module is respectively connected to the text extraction module and the timbre extraction module. The text extraction module is configured to obtain the text feature in the first speech, the timbre extraction module is configured to obtain the timbre feature in the first speech, and the accent synthesis module is configured to process the text feature, the timbre feature, and the target accent feature learned by the accent synthesis module, to obtain the second speech. As such, during accent conversion on the first speech, the speech processing model can perform accent conversion on any segment of speech, improving the accent conversion flexibility of and the accent conversion accuracy.

S205: The second speech is played.

Alternatively, after the electronic device obtains the second speech, the electronic device may play the second speech. For example, in a scenario of accent conversion, after the electronic device determines the target accent in response to the operation of the user, the user may input the first speech in real time to the electronic device, and the electronic device may convert the accent of the first speech into the target accent to obtain the second speech and then play the second speech, so that the user can quickly determine an accent conversion quality with respect to the second speech, thereby improving an accent conversion effect. It should be noted that there is no sequential relationship between the determining of the target accent and the obtaining of the first speech that are performed by the electronic device, and the electronic device may first obtain the first speech and then determine the target accent, which is not limited in the embodiments of the present disclosure.

The embodiment of the present disclosure provides the speech processing method, in which the electronic device displays the accent conversion page; obtains the identifier of the target accent and the first speech in response to touch operations on the accent control and the speech obtaining control on the accent conversion page; determines the target accent feature based on the identifier of the target accent; processes the first speech based on the speech processing model, to obtain the text feature and the timbre feature associated with the first speech; processes the text feature, the timbre feature, and the target accent feature based on the speech processing model, to obtain the second speech; and plays the second speech, where the accent of the second speech is the target accent. As such, the electronic device does not need to obtain, in the database, speech of the target accent that has text content the same as that of the first speech. The speech processing model can accurately perform accent conversion on any segment of the first speech, and can retain the timbre and content of the first speech, thereby improving the accent conversion accuracy.

Based on the embodiment shown in FIG. 2, a process of the above speech processing method is described below with reference to FIG. 6.

FIG. 6 is a schematic diagram of the process of the speech processing method according to an embodiment of the present disclosure. Referring to FIG. 6, the speech processing model is included. The speech processing model may include the text extraction module, the timbre extraction module, and the accent synthesis module, where the accent synthesis module is respectively connected to the text extraction module and the timbre extraction module. The electronic device (not shown in FIG. 6) may respectively input the first speech to the text extraction module and the timbre extraction module, and input the identifier of the target accent to the accent synthesis module.

Referring to FIG. 6, the text extraction module may process the first speech to obtain the text feature of the first speech and input the text feature to the accent synthesis module. The timbre extraction module may process the first speech to obtain the timbre feature of the first speech and input the timbre feature to the accent synthesis module. The accent synthesis module determines the target accent feature based on the identifier of the target accent and generates the second speech based on the text feature, the timbre feature, and the target accent feature. Text and timbre of the second speech are the same as those of the first speech, and the accent of the second speech is the target accent. As such, the electronic device can accurately perform accent conversion on any segment of speech, thereby improving the accent conversion accuracy.

Based on any of the above embodiments, the above speech processing method further comprises a method for training the speech processing model. The method for training the speech processing model is described in detail below with reference to FIG. 7.

FIG. 7 is a schematic flowchart of the method for training the speech processing model according to an embodiment of the present disclosure. Referring to FIG. 7, a process of the method includes the following steps.

S701: Sample speech is obtained.

Since the sample speech may be speech of non-parallel data, the electronic device can obtain the sample speech in the database. For example, the database of a server may include a plurality of pieces of public speech data, and the electronic device may obtain the speech data in the database and determine the public speech data as the sample speech. It should be noted that the electronic device may also obtain the sample speech in other methods (for example, obtain public speech data in a network as the sample speech), which is not limited in the embodiments of the present disclosure.

S702: A sample target accent is determined.

Alternatively, the sample target accent may be any accent. For example, the sample target accent may be a common standard accent or a dialect. During practical application, the sample target accent may be determined based on a requirement of the speech processing model. For example, if the speech processing model is required to convert an accent of any segment of speech into the accent A, the sample target accent is the accent A, and if the speech processing model is required to convert an accent of any segment of speech into the accent B, the sample target accent is the accent B.

It should be noted that the speech processing model can learn a plurality of sample target accents during training, thereby implementing an effect of conversion between a plurality of accents. For example, during training of the speech processing model, if the sample target accent may include the accent A and the accent B, the speech processing model can convert the accent of any segment of speech into the accent A or the accent B when the training is completed.

S703: Target sample speech and non-target sample speech are determined in the sample speech based on the sample target accent.

Alternatively, an accent of the target sample speech is the same as the sample target accent, and an accent of the non-target sample speech is different from the sample target accent. For example, if the sample speech includes speech A, speech B, and speech C, an accent of speech A is an accent a, an accent of the speech B is an accent b, an accent of the speech C is an accent c, and the sample target accent is the accent a, then the electronic device determines that the target sample speech includes the speech A, and the non-target sample speech includes the speech B and the speech C; and if the sample target accent is the accent a and the accent b, the electronic device determines that the target sample speech includes the speech A and the speech B, and the non-target sample speech includes the speech C.

Alternatively, after obtaining the sample speech, the electronic device may determine an accent of each piece of sample speech by means of an accent detection algorithm, and then classify the sample speech based on the sample target accent. It should be noted that the electronic device may alternatively obtain an accent of the sample speech based on other methods, which is not limited in the embodiments of the present disclosure.

S704: A speech processing model is updated based on the target sample speech and the non-target sample speech.

Alternatively, the speech processing model includes the text extraction module, the timbre extraction module, and the accent synthesis module, and therefore, the text extraction module, the timbre extraction module, and the accent synthesis module can be trained together during training of the speech processing model.

Alternatively, during training, the speech processing model further requires an auxiliary training module to assist in the training, where the auxiliary training module can obtain an accent feature in speech. During practical training, the accent synthesis module is trained with only the target sample speech, while the auxiliary training module is trained with the target sample speech and the non-target sample speech.

Alternatively, during training, the speech processing model further includes an adversarial accent discriminator, where the adversarial accent discriminator may be connected to the text extraction module, and when the text extraction module outputs the text feature, the adversarial accent discriminator may process the text feature and output a distribution probability of the text feature belonging to each accent. In a design of a loss function, after the text feature output by the text extraction module is input to the adversarial accent discriminator, probabilities of the text feature belonging to all the accents that are output by the adversarial accent discriminator are the same, indicating that the text feature output by the text extraction module contains few accent information, thereby improving accuracy of the text feature.

Alternatively, during training, the speech processing model further includes a timbre augmentation module, where the timbre augmentation module may be connected to the timbre extraction module, and the timbre augmentation module can augment a timbre of the sample speech, so that the speech processing model can learn more timbres. As such, when the training of the speech processing model is completed, the speech processing model can perform accent conversion on speech of any timbre, thereby improving the accent conversion flexibility and the accent conversion accuracy.

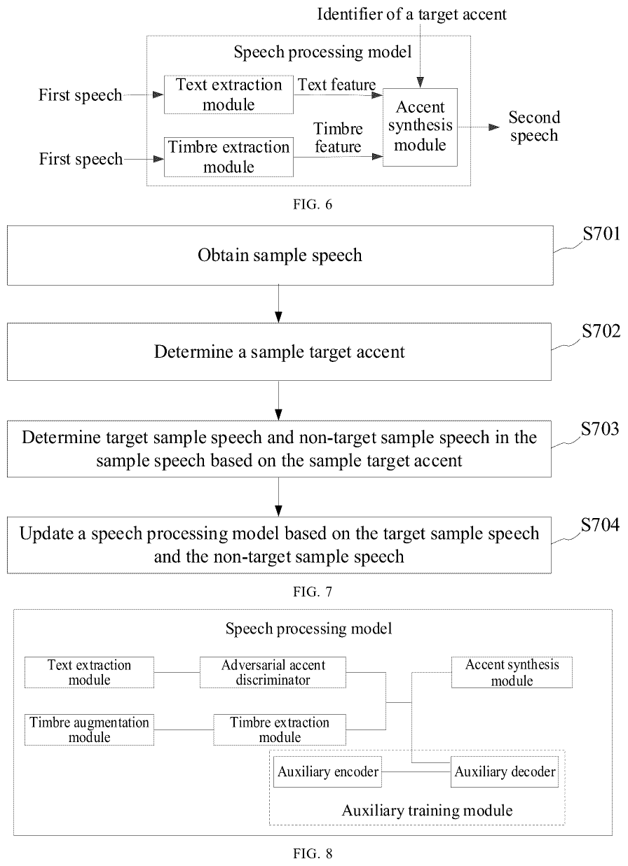

A structure of the speech processing model in training is described below with reference to FIG. 8.

FIG. 8 is a schematic diagram of the structure of the speech processing model in training according to an embodiment of the present disclosure. Referring to FIG. 8, the speech processing model is included. The speech processing model includes the text extraction module, the adversarial accent discriminator, the timbre augmentation module, the timbre extraction module, the accent synthesis module, and the auxiliary training module, where the auxiliary training module includes an auxiliary encoder and an auxiliary decoder. The adversarial accent discriminator is respectively connected to the text extraction module, the accent synthesis module, the auxiliary decoder, and the timbre extraction module is respectively connected to the timbre augmentation module, the accent synthesis module, and the auxiliary decoder, and the auxiliary decoder is further connected to the auxiliary encoder.

Alternatively, the text extraction module is configured to obtain a text feature of the sample speech; the adversarial accent discriminator is configured to determine, based on the text feature, an accent category to which the text feature belongs; the timbre augmentation module is configured to perform timbre augmentation on the timbre of the sample speech; the timbre extraction module is configured to obtain a timbre feature of the sample speech that has undergone the timbre augmentation; the accent synthesis module is configured to generate speech based on the text feature and the timbre feature; the auxiliary decoder is configured to generate speech based on the text feature, the timbre feature, and an accent feature; and the auxiliary encoder is configured to obtain an accent feature in speech.

It should be noted that the structure of the speech processing model shown in FIG. 8 is a structure in a training stage. After the training is ended, the adversarial accent discriminator, the timbre augmentation module, and the auxiliary training module are not required during use of the speech processing model, while only the text extraction module, the timbre extraction module, and the accent synthesis module are retained during the use of the speech processing model.

Alternatively, there are the following two cases for the electronic device updating the speech processing model based on the target sample speech and the non-target sample speech.

Case 1: A training sample includes the target sample speech.

For the target sample speech, the electronic device updating the speech processing model based on the target sample speech is specifically as follows: processing the target sample speech based on the text extraction module, to obtain a target sample text feature; performing timbre augmentation on a timbre of the target sample speech, and processing, based on the timbre extraction module, the target sample speech that has undergone the timbre augmentation, to obtain a target sample timbre feature; obtaining a first target audio feature of the target sample speech that has undergone the timbre augmentation; and updating the speech processing model based on the accent synthesis module, the target sample speech, the target sample text feature, the target sample timbre feature, and the first target audio feature.

Updating the speech processing model based on the accent synthesis module, the target sample speech, the target sample text feature, the target sample timbre feature, and the first target audio feature is specifically as follows: processing the target sample text feature and the target sample timbre feature based on the accent synthesis module, to determine a first predicted target audio feature; processing the target sample speech based on the auxiliary training module, to obtain an accent feature of the target sample speech; processing the target sample text feature, the target sample timbre feature, and the accent feature of the target sample speech based on the auxiliary training module, to obtain a second predicted target audio feature; and updating the speech processing model based on the first predicted target audio feature, the second predicted target audio feature, and the first target audio feature.

Alternatively, the electronic device may perform the timbre augmentation on the timbre of the target sample speech based on the timbre augmentation module. For example, the timbre augmentation module may include a timbre augmentation algorithm, and may process the target sample speech by means of the timbre augmentation algorithm, so that the timbre of the target sample speech can be changed, thereby achieving the timbre augmentation.

During training, the accent synthesis module may determine the first predicted target audio feature based on the target sample text feature and the target sample timbre feature, and then a parameter of the accent synthesis module may be updated by means of a loss between the first predicted target audio feature and the first target audio feature. When the training is ended, the accent synthesis module may learn the accent feature associated with the sample target accent.

Alternatively, after the electronic device obtains the target sample text feature through the text extraction module, the target sample text feature may be output to the adversarial accent discriminator, and then a first loss of the speech processing model may be determined by means of a distribution probability of the target sample text feature belonging an accent category and a uniform distribution probability that are output by the adversarial accent discriminator.

Alternatively, the electronic device may, through a feature extraction network, process the target sample speech that has undergone the timbre augmentation, thereby obtaining the first target audio feature. It should be noted that the first target audio feature may be an audio waveform, a spectrogram, etc., which is not limited in the embodiments of the present disclosure. If the first target audio feature is a spectrogram, a vocoder may also be connected to output ends of the accent synthesis module and the auxiliary decoder, so as to recover the spectrogram into a waveform through the vocoder.

Alternatively, the electronic device may determine a second loss of the speech processing model based on the first predicted target audio feature and the first target audio feature, and the electronic device may further determine a third loss based on the second predicted target audio feature and the first target audio feature, so as to train the speech processing model based on the first loss, the second loss, and the third loss.

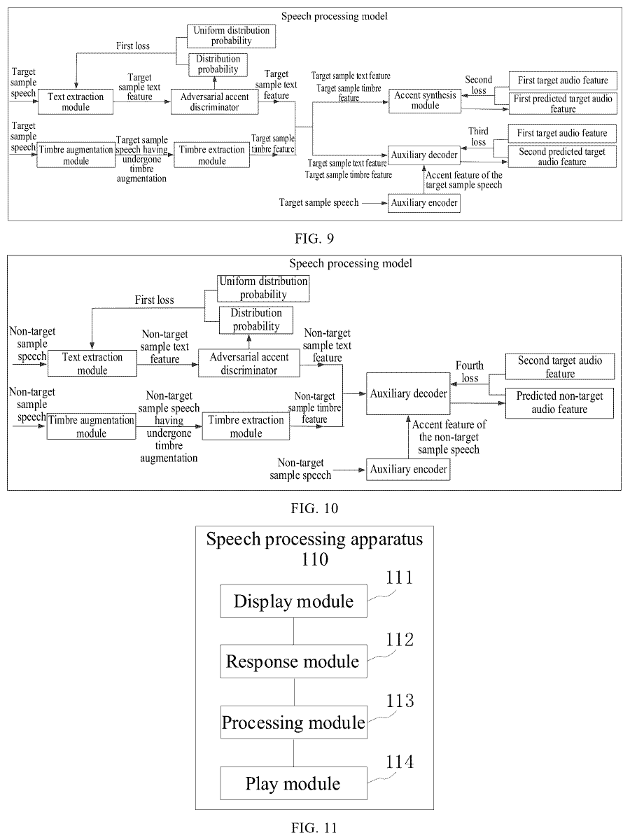

A training process of the speech processing model that is based on the target sample speech is described below with reference to FIG. 9.

FIG. 9 shows the training process of the speech processing model according to an embodiment of the present disclosure. Referring to FIG. 9, the speech processing model is included. The speech processing model includes the text extraction module, the timbre augmentation module, the adversarial accent discriminator, the timbre extraction module, the accent synthesis module, the auxiliary encoder, and the auxiliary decoder.

Referring to FIG. 9, the target sample speech is input to the text extraction module; the text extraction module may input the target sample text feature to the adversarial accent discriminator; based on the target sample text feature, the adversarial accent discriminator outputs distribution probabilities of the target sample text feature belonging to a plurality of accent categories; the speech processing model determines the first loss based on the distribution probabilities and the uniform distribution probability, and then updates a parameter in the text extraction module based on the first loss; and the adversarial accent discriminator may input the target sample text feature to the accent synthesis module and the auxiliary decoder.

Referring to FIG. 9, the target sample speech is input to the timbre augmentation module; after the timbre augmentation module performs the timbre augmentation on the target sample speech, the target sample speech that has undergone the timbre augmentation is input to the timbre extraction module; and the timbre extraction module obtains the target sample timbre feature corresponding to the target sample speech that has undergone the timbre augmentation and then inputs the target sample timbre feature to the accent synthesis module and the auxiliary decoder.

Referring to FIG. 9, the accent synthesis module determines the first predicted target audio feature based on the target sample text feature and the target sample timbre feature. The speech processing model determines, based on the target sample speech that has undergone the timbre augmentation, the first target audio feature corresponding to the speech, and then determines the second loss based on the first predicted target audio feature and the first target audio feature. The accent synthesis module may learn the accent feature of the sample target speech based on the second loss.

Referring to FIG. 9, the target sample speech is input to the auxiliary encoder; the auxiliary encoder may determine the accent feature of the target sample speech and then input the accent feature of the target sample speech to the auxiliary decoder; and the auxiliary decoder determines the second predicted target audio feature based on the target sample text feature, the target sample timbre feature, and the accent feature of the target sample speech. The speech processing model determines the third loss based on the second predicted target audio feature and the first target audio feature, and the speech processing model updates, based on the second loss and the third loss, parameters in modules, such as the accent synthesis module, the auxiliary decoder, the text extraction module, and the timbre augmentation module.

Case 2: A training sample includes the non-target sample speech.

For the non-target sample speech, the electronic device updating the speech processing model based on the non-target sample speech is specifically as follows: processing the non-target sample speech based on the text extraction module, to obtain a non-target sample text feature; performing timbre augmentation on a timbre of the non-target sample speech, and processing, based on the timbre extraction module, the non-target sample speech that has undergone the timbre augmentation, to obtain a non-target sample timbre feature; obtaining an accent feature of the non-target sample speech based on an auxiliary training module, and determining a predicted non-target audio feature based on the non-target sample text feature, the non-target sample timbre feature, and the accent feature of the non-target sample speech; and obtaining a second target audio feature of the non-target sample speech that has undergone the timbre augmentation, and updating the speech processing model based on the predicted non-target audio feature and the second target audio feature.

Alternatively, a method of performing the timbre augmentation on the non-target sample speech by the electronic device is the same as that in Case 1, a method of by processing the non-target sample text feature through the adversarial accent discriminator by the electronic device is the same as that in Case 1, and a method of obtaining the second target audio feature by the electronic device is the same as that in Case 1, which are no longer described repeatedly in this embodiment of the present disclosure.

Alternatively, the electronic device may process the non-target sample speech based on the auxiliary encoder in the auxiliary training module, to obtain the accent feature of the non-target sample speech, and then input the accent feature of the non-target sample speech to the auxiliary decoder.

Alternatively, the electronic device may determine a fourth loss of the speech processing model based on the predicted non-target audio feature and the second target audio feature, and then train the speech processing model based on the fourth loss.

A training process of the speech processing model that is based on the non-target sample speech is described below with reference to FIG. 10.

FIG. 10 shows another training process of the speech processing model according to an embodiment of the present disclosure. Referring to FIG. 10, the speech processing model is included. The speech processing model includes the text extraction module, the timbre augmentation module, the adversarial accent discriminator, the timbre extraction module, the auxiliary encoder, and the auxiliary decoder (the accent synthesis module is not required during training of the non-target sample speech and is therefore not shown in FIG. 10).

Referring to FIG. 10, the non-target sample speech is input to the text extraction module; the text extraction module may input the non-target sample text feature to the adversarial accent discriminator; based on the non-target sample text feature, the adversarial accent discriminator outputs distribution probabilities of the non-target sample text feature belonging to a plurality of accent categories; the speech processing model determines the first loss based on the distribution probabilities and the uniform distribution probability, and then updates the parameter in the text extraction module based on the first loss; and the adversarial accent discriminator may input the non-target sample text feature to the auxiliary decoder.

Referring to FIG. 10, the non-target sample speech is input to the timbre augmentation module; after the timbre augmentation module performs the timbre augmentation on the non-target sample speech, the non-target sample speech that has undergone the timbre augmentation is input to the timbre extraction module; and the timbre extraction module obtains the non-target sample timbre feature corresponding to the non-target sample speech that has undergone the timbre augmentation and then inputs the non-target sample timbre feature to the auxiliary decoder.

Referring to FIG. 10, the non-target sample speech is input to the auxiliary encoder, the auxiliary encoder may process the non-target sample speech, to obtain the accent feature of the non-target sample speech, and then input the accent feature of the non-target sample speech to the auxiliary decoder.

Referring to FIG. 10, the auxiliary decoder determines the predicted non-target audio feature based on the non-target sample text feature, the non-target sample timbre feature, and the accent feature of the non-target sample speech, and then determines the fourth loss based on the predicted non-target audio feature and the second target audio feature corresponding to the non-target sample speech that has undergone the timbre augmentation. The speech processing model updates, based on the fourth loss, the parameters in modules, such as the accent synthesis module, the auxiliary decoder, the text extraction module, and the timbre augmentation module.

This embodiment of the present disclosure provides a method for training the speech processing model, in which the sample speech is obtained, the sample target accent is determined, the target sample speech and the non-target sample speech are determined in the sample speech based on the sample target accent, and the speech processing model is updated based on the target sample speech and the non-target sample speech. As such, when the sample speech varies, the speech processing model may be trained based on training methods described in the above two cases. Accuracy of the text extraction module may be improved through the adversarial accent discriminator, resulting in fewer accent information in the text feature (the accent information cannot affect accent classification). The timbre augmentation module may enable the speech processing model to learn more timbres, thereby improving applicability of the model. Since the auxiliary encoder can output more accent features, the auxiliary decoder may obtain an accent feature through the auxiliary encoder, thereby reducing a probability of obtaining accent information from the text extraction module, so that the text extraction module can filter out more accent information, further improving the accuracy of the text extraction module. As such, the speech processing model can determine accurate text feature and timbre feature in any segment of speech, thereby improving the accent conversion accuracy.

FIG. 11 is a schematic diagram of a structure of a speech processing apparatus according to an embodiment of the present disclosure. Referring to FIG. 11, the speech processing apparatus 110 includes a display module 111, a response module 112, a processing module 113, and a play module 114, where
the display module 111 is configured to display an accent conversion page, where the accent conversion page includes an accent control associated with a target accent, and a speech obtaining control;
the response module 112 is configured to determine an identifier of the target accent in response to a touch operation on the accent control;
the response module 112 is further configured to obtain the first speech in response to a touch operation on the speech obtaining control, where the target accent is different from an accent of the first speech;
the processing module 113 is configured to perform accent conversion on the first speech based on the first speech and the identifier of the target accent, to obtain second speech, where an accent of the second speech is the target accent, the accent conversion is implemented based on a speech processing model, and the speech processing model is obtained by training based on sample speech of non-parallel data; and
the play module 114 is configured to play the second speech.

According to one or more embodiments of the present disclosure, the processing module 113 is specifically configured to:
determine a target accent feature based on the identifier of the target accent;
process the first speech based on the speech processing model, to obtain a text feature and a timbre feature associated with the first speech; and
process the text feature, the timbre feature, and the target accent feature based on the speech processing model, to obtain the second speech.

According to one or more embodiments of the present disclosure, the response module 112 is specifically configured to:
display a speech page in response to the touch operation on the speech obtaining control, where the speech page includes at least one piece of target speech; and
determine the target speech as the first speech in response to a touch operation on the target speech.

According to one or more embodiments of the present disclosure, the response module 112 is specifically configured to:
perform speech recording in response to the touch operation on the speech obtaining control, to obtain the first speech.

The speech processing apparatus provided in this embodiment may be configured to perform the technical solution of the above method embodiment. The implementation principles and technical effects thereof are similar, which are not repeated in this embodiment.

FIG. 12 is a schematic diagram of a structure of another speech processing apparatus according to an embodiment of the present disclosure. Based on the embodiment shown in FIG. 11, referring to FIG. 12, the speech processing apparatus further includes a training module 115. The training module 115 is configured to:
obtain sample speech;
determine a sample target accent;
determine target sample speech and non-target sample speech in the sample speech based on the sample target accent, where an accent of the target sample speech is the same as the sample target accent, and an accent of the non-target sample speech is different from the sample target accent; and
update the speech processing model based on the target sample speech and the non-target sample speech.

According to one or more embodiments of the present disclosure, the training module 115 is specifically configured to:
process the target sample speech based on the text extraction module, to obtain a target sample text feature;
perform timbre augmentation on a timbre of the target sample speech, and process, based on the timbre extraction module, the target sample speech that has undergone the timbre augmentation, to obtain a target sample timbre feature;
obtain a first target audio feature of the target sample speech that has undergone the timbre augmentation; and
update the speech processing model based on the accent synthesis module, the target sample speech, the target sample text feature, the target sample timbre feature, and the first target audio feature.

According to one or more embodiments of the present disclosure, the training module 115 is specifically configured to:
process the target sample text feature and the target sample timbre feature based on the accent synthesis module, to determine a first predicted target audio feature;
process the target sample speech based on an auxiliary training module, to obtain an accent feature of the target sample speech;
process the target sample text feature, the target sample timbre feature, and the accent feature of the target sample speech based on the auxiliary training module, to obtain a second predicted target audio feature; and
update the speech processing model based on the first predicted target audio feature, the second predicted target audio feature, and the first target audio feature.

According to one or more embodiments of the present disclosure, the training module 115 is specifically configured to:
process the non-target sample speech based on the text extraction module, to obtain a non-target sample text feature;
perform timbre augmentation on a timbre of the non-target sample speech, and process, based on the timbre extraction module, the non-target sample speech that has undergone the timbre augmentation, to obtain a non-target sample timbre feature;
obtain an accent feature of the non-target sample speech based on an auxiliary training module, and determine a predicted non-target audio feature based on the non-target sample text feature, the non-target sample timbre feature, and the accent feature of the non-target sample speech; and
obtain a second target audio feature of the non-target sample speech that has undergone the timbre augmentation, and update the speech processing model based on the predicted non-target audio feature and the second target audio feature.

The speech processing apparatus provided in this embodiment may be configured to perform the technical solution of the above method embodiment. The implementation principles and technical effects thereof are similar, which are not repeated in this embodiment.

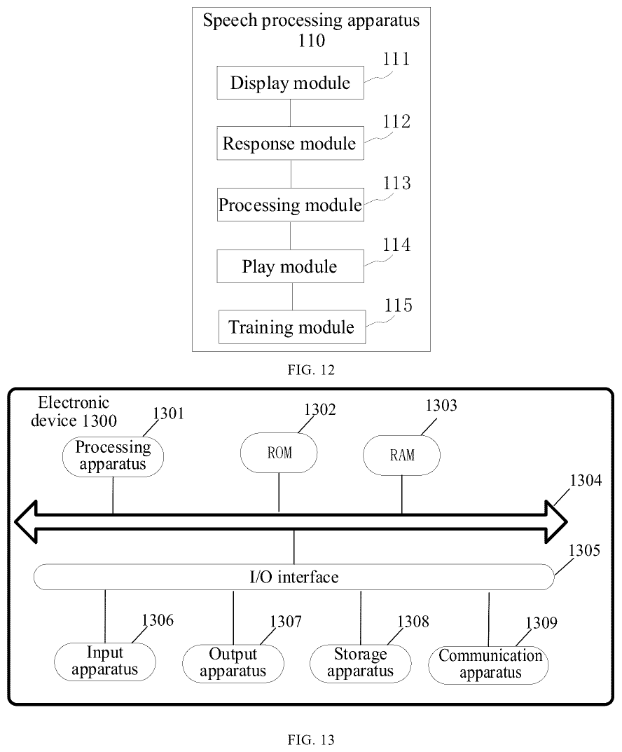

FIG. 13 is a schematic diagram of a structure of an electronic device according to an embodiment of the present disclosure. Referring to FIG. 13, which is a schematic diagram of a structure of an electronic device 1300 suitable for implementing the embodiments of the present disclosure. The electronic device 1300 may be a terminal device or a server. The terminal device may include, but is not limited to, a mobile terminal such as a mobile phone, a notebook computer, a digital broadcast receiver, a personal digital assistant (PDA), a tablet computer (portable Android device, PAD), a portable media player (PMP), and a vehicle-mounted terminal (such as a vehicle navigation terminal), and a fixed terminal such as a digital TV and a desktop computer. The electronic device shown in FIG. 13 is merely an example, and shall not impose any limitation on the function and scope of use of the embodiments of the present disclosure.

As shown in FIG. 13, the electronic device 1300 may include a processing apparatus (e.g., a central processing unit or a graphics processing unit) 1301 that may perform a variety of appropriate actions and processing in accordance with a program stored in a read-only memory (ROM) 1302 or a program loaded from a storage apparatus 1308 into a random access memory (RAM) 1303. The RAM 1303 further stores various programs and data required for the operation of the electronic device 1300. The processing apparatus 1301, the ROM 1302, and the RAM 1303 are connected to each other through a bus 1304. An input/output (I/O) interface 1305 is also connected to the bus 1304.

Generally, the following apparatuses may be connected to the I/O interface 1305: an input apparatus 1306 including, for example, a touchscreen, a touchpad, a keyboard, a mouse, a camera, a microphone, an accelerometer, and a gyroscope; an output apparatus 1307 including, for example, a liquid crystal display (LCD), a speaker, and a vibrator; the storage apparatus 1308 including, for example, a tape and a hard disk; and a communication apparatus 1309. The communication apparatus 1309 may allow the electronic device 1300 to perform wireless or wired communication with other devices to exchange data. Although FIG. 13 shows the electronic device 1300 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded from a network through the communication apparatus 1309 and installed, installed from the storage apparatus 1308, or installed from the ROM 1302. When the computer program is executed by the processing apparatus 1301, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to perform the method shown in the above embodiment.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user via any kind of network, including a local area network (LAN) or a wide area network (WAN), or may be connected to an external computer (for example, connected via the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions. The data may include information, parameters, messages, etc., such as traffic split indication information.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A speech processing method, comprising:
displaying an accent conversion page, wherein the accent conversion page comprises an accent control associated with a target accent, and a speech obtaining control;
determining an identifier of the target accent in response to a touch operation on the accent control;
obtaining first speech in response to a touch operation on the speech obtaining control, wherein the target accent is different from an accent of the first speech;
performing accent conversion on the first speech based on the first speech and the identifier of the target accent, to obtain second speech, wherein an accent of the second speech is the target accent, the accent conversion is implemented based on a speech processing model, and the speech processing model is obtained through training based on sample speech of non-parallel data; and
playing the second speech.

2. The method according to claim 1, wherein performing accent conversion on the first speech based on the first speech and the identifier of the target accent, to obtain second speech, comprises:
determining a target accent feature based on the identifier of the target accent;
processing the first speech based on the speech processing model, to obtain a text feature and a timbre feature associated with the first speech; and
processing the text feature, the timbre feature, and the target accent feature based on the speech processing model, to obtain the second speech.

3. The method according to claim 1, wherein obtaining the first speech in response to the touch operation on the speech obtaining control comprises:
displaying a speech page in response to the touch operation on the speech obtaining control, wherein the speech page comprises at least one piece of target speech; and
determining the target speech as the first speech in response to a touch operation on the target speech.

4. The method according to claim 1, wherein obtaining the first speech in response to the touch operation on the speech obtaining control comprises:
performing speech recording in response to the touch operation on the speech obtaining control, to obtain the first speech.

5. The method according to claim 1, wherein the speech processing model is determined through the following steps:
obtaining sample speech;
determining a sample target accent;
determining target sample speech and non-target sample speech in the sample speech based on the sample target accent, wherein an accent of the target sample speech is the same as the sample target accent, and an accent of the non-target sample speech is different from the sample target accent; and
updating the speech processing model based on the target sample speech and the non-target sample speech.

6. The method according to claim 5, wherein the speech processing model comprises a text extraction module, a timbre extraction module, and an accent synthesis module; and for the target sample speech, updating the speech processing model based on the target sample speech comprises:
processing the target sample speech based on the text extraction module, to obtain a target sample text feature;
performing timbre augmentation on a timbre of the target sample speech, and processing, based on the timbre extraction module, the target sample speech that has undergone the timbre augmentation, to obtain a target sample timbre feature;
obtaining a first target audio feature of the target sample speech that has undergone the timbre augmentation; and
updating the speech processing model based on the accent synthesis module, the target sample speech, the target sample text feature, the target sample timbre feature, and the first target audio feature.

7. The method according to claim 6, wherein updating the speech processing model based on the accent synthesis module, the target sample speech, the target sample text feature, the target sample timbre feature, and the first target audio feature comprises:
processing the target sample text feature and the target sample timbre feature based on the accent synthesis module, to determine a first predicted target audio feature;
processing the target sample speech based on an auxiliary training module, to obtain an accent feature of the target sample speech;
processing the target sample text feature, the target sample timbre feature, and the accent feature of the target sample speech based on the auxiliary training module, to obtain a second predicted target audio feature; and
updating the speech processing model based on the first predicted target audio feature, the second predicted target audio feature, and the first target audio feature.

8. The method according to claim 6, wherein for the non-target sample speech, updating the speech processing model based on the non-target sample speech comprises:
processing the non-target sample speech based on the text extraction module, to obtain a non-target sample text feature;
performing timbre augmentation on a timbre of the non-target sample speech, and processing, based on the timbre extraction module, the non-target sample speech that has undergone the timbre augmentation, to obtain a non-target sample timbre feature;
obtaining an accent feature of the non-target sample speech based on an auxiliary training module, and determining a predicted non-target audio feature based on the non-target sample text feature, the non-target sample timbre feature, and the accent feature of the non-target sample speech; and
obtaining a second target audio feature of the non-target sample speech that has undergone the timbre augmentation, and updating the speech processing model based on the predicted non-target audio feature and the second target audio feature.

9. (canceled)

10. An electronic device, comprising a processor and a memory,
wherein the memory stores computer-executable instructions; and
the computer-executable instructions when executed by a processor, cause the processor to:
display an accent conversion page, wherein the accent conversion page comprises an accent control associated with a target accent, and a speech obtaining control;
determine an identifier of the target accent in response to a touch operation on the accent control;
obtain first speech in response to a touch operation on the speech obtaining control, wherein the target accent is different from an accent of the first speech;
perform accent conversion on the first speech based on the first speech and the identifier of the target accent, to obtain second speech, wherein an accent of the second speech is the target accent, the accent conversion is implemented based on a speech processing model, and the speech processing model is obtained through training based on sample speech of non-parallel data; and
play the second speech.

11. A non-transitory computer-readable storage medium, having stored therein computer-executable instructions that, when executed by a processor, cause the processor to:
display an accent conversion page, wherein the accent conversion page comprises an accent control associated with a target accent, and a speech obtaining control;
determine an identifier of the target accent in response to a touch operation on the accent control;
obtain first speech in response to a touch operation on the speech obtaining control, wherein the target accent is different from an accent of the first speech;
perform accent conversion on the first speech based on the first speech and the identifier of the target accent, to obtain second speech, wherein an accent of the second speech is the target accent, the accent conversion is implemented based on a speech processing model, and the speech processing model is obtained through training based on sample speech of non-parallel data; and
play the second speech.

12. The electronic device according to claim 10, wherein the computer-executable instructions, when causing the processor to perform accent conversion on the first speech based on the first speech and the identifier of the target accent, to obtain second speech, cause the processor to:
determine a target accent feature based on the identifier of the target accent;
process the first speech based on the speech processing model, to obtain a text feature and a timbre feature associated with the first speech; and
process the text feature, the timbre feature, and the target accent feature based on the speech processing model, to obtain the second speech.

13. The electronic device according to claim 10, wherein the computer-executable instructions, when causing the processor to obtain the first speech in response to the touch operation on the speech obtaining control, cause the processor to:
display a speech page in response to the touch operation on the speech obtaining control, wherein the speech page comprises at least one piece of target speech; and
determine the target speech as the first speech in response to a touch operation on the target speech.

14. The electronic device according to claim 10, wherein the computer-executable instructions, when causing the processor to obtain the first speech in response to the touch operation on the speech obtaining control, cause the processor to:
perform speech recording in response to the touch operation on the speech obtaining control, to obtain the first speech.

15. The electronic device to claim 10, wherein the speech processing model is determined through the following steps:
obtaining sample speech;
determining a sample target accent;
determining target sample speech and non-target sample speech in the sample speech based on the sample target accent, wherein an accent of the target sample speech is the same as the sample target accent, and an accent of the non-target sample speech is different from the sample target accent; and
updating the speech processing model based on the target sample speech and the non-target sample speech.

16. The electronic device according to claim 15, wherein the speech processing model comprises a text extraction module, a timbre extraction module, and an accent synthesis module; and for the target sample speech, the computer-executable instructions, when causing the processor to update the speech processing model based on the target sample speech, cause the processor to:
process the target sample speech based on the text extraction module, to obtain a target sample text feature;
perform timbre augmentation on a timbre of the target sample speech, and process, based on the timbre extraction module, the target sample speech that has undergone the timbre augmentation, to obtain a target sample timbre feature;
obtain a first target audio feature of the target sample speech that has undergone the timbre augmentation; and
update the speech processing model based on the accent synthesis module, the target sample speech, the target sample text feature, the target sample timbre feature, and the first target audio feature.

17. The electronic device according to claim 16, wherein the computer-executable instructions, when causing the processor to update the speech processing model based on the accent synthesis module, the target sample speech, the target sample text feature, the target sample timbre feature, and the first target audio feature, cause the processor to:
process the target sample text feature and the target sample timbre feature based on the accent synthesis module, to determine a first predicted target audio feature;
process the target sample speech based on an auxiliary training module, to obtain an accent feature of the target sample speech;
process the target sample text feature, the target sample timbre feature, and the accent feature of the target sample speech based on the auxiliary training module, to obtain a second predicted target audio feature; and
update the speech processing model based on the first predicted target audio feature, the second predicted target audio feature, and the first target audio feature.

18. The electronic device according to claim 16, wherein for the non-target sample speech, the computer-executable instructions, when causing the processor to update the speech processing model based on the non-target sample speech, cause the processor to:
process the non-target sample speech based on the text extraction module, to obtain a non-target sample text feature;
perform timbre augmentation on a timbre of the non-target sample speech, and process, based on the timbre extraction module, the non-target sample speech that has undergone the timbre augmentation, to obtain a non-target sample timbre feature;
obtain an accent feature of the non-target sample speech based on an auxiliary training module, and determine a predicted non-target audio feature based on the non-target sample text feature, the non-target sample timbre feature, and the accent feature of the non-target sample speech; and
obtain a second target audio feature of the non-target sample speech that has undergone the timbre augmentation, and update the speech processing model based on the predicted non-target audio feature and the second target audio feature.

19. The non-transitory computer-readable storage medium according to claim 11, wherein the computer-executable instructions, when causing the processor to perform accent conversion on the first speech based on the first speech and the identifier of the target accent, to obtain second speech, cause the processor to:
determine a target accent feature based on the identifier of the target accent;
process the first speech based on the speech processing model, to obtain a text feature and a timbre feature associated with the first speech; and
process the text feature, the timbre feature, and the target accent feature based on the speech processing model, to obtain the second speech.

20. The non-transitory computer-readable storage medium according to claim 11, wherein the computer-executable instructions, when causing the processor to obtain the first speech in response to the touch operation on the speech obtaining control, cause the processor to:
display a speech page in response to the touch operation on the speech obtaining control, wherein the speech page comprises at least one piece of target speech; and
determine the target speech as the first speech in response to a touch operation on the target speech.

21. The non-transitory computer-readable storage medium according to claim 11, wherein the computer-executable instructions, when causing the processor to obtain the first speech in response to the touch operation on the speech obtaining control, cause the processor to:
perform speech recording in response to the touch operation on the speech obtaining control, to obtain the first speech.
